(19) United States
(12) Patent Application Publication
(10) Pub. No.: US 2008/0036194 A1
(43) Pub. Date: Feb. 14, 2008

(54) Hidden image

(75) Inventors: Monique Golaire, Linkebeek (BE); Maryke Degryse, Assebroek (BE); Nathalie Paquot, Emines (BE); Paul Van Braeckel, Meigem (BE); Beni Haeyaert, Assebroek (BE)

Correspondence Address: JAMES C. WRAY, 1493 CHAIN BRIDGE ROAD, SUITE 300, MCLEAN, VA, 22101, US

(73) Assignee: National Bank of Belgium

(21) Appl. No.: 11/715,613

(22) Filed: Mar. 8, 2007

(30) Foreign Application Priority Data
Aug. 11, 2006 (EP) 06118812.4

(51) Int. Cl. B42D 15/00

(52) U.S. Cl. 283/67; 283/74

(57) ABSTRACT

The invention relates to a new method for printing a security item on a substrate of which at least a part is made of a transparent material, a first part (3) of an image (2) being printed on one side of the transparent material, and a second complementary part (4) of the image (2) being printed on the opposite side of the transparent material such that, at least some angles (P°) of view, the image (2) is visible or can be visualised as a whole in which the first (3) and second (4) part of the image (2) are not distinguishable.

The present invention relates to a method for printing a security item on a substrate of which at least a part is made of a transparent material, and in particular to a method for printing a security item on security documents, on a part of a security document or on a substrate that can be transferred to a security document. Security documents are in particular: banknotes, postage stamps, identity cards, passports, checks, certificates, certificates of authenticity, . . . . The present invention relates also to a printed security item manufactured according to such a method.

Printing security items, so called security printing is an application or combination of printing technologies such as offset, intaglio, silkscreen and letterpress. Security printing encompasses the printing of banknotes, postage stamps, stamps, stock certificates, identity cards, passports, checks, deeds, plane tickets, diploma's and other documents needing a protection against counterfeiting.

Security papers, such as banknotes circulate in a world where the threat of the counterfeiter is ever present. With the development of new printing processes and the introduction of new technologies, more methods of reproduction are available to the counterfeiter than ever before. It is therefore essential that security documents, such as banknotes should be practically forgeryproof. This is achieved not only by the way in which the printing technologies and their combinations are used, but also through the nature of the substrate and the ink, and the use of special additional elements such as security threads, holograms, and so on.

Banknotes are generally printed on a substrate made of 100% cotton and are further protected by a watermark, a security thread, fluorescent fibres of different colours and length, optical variable inks or other visual or machine detectable characteristics.

However, a disadvantage of such banknotes is their restricted lifespan. Banknotes in a synthetic material do not have this drawback, as they can last about four times as long as the conventional cotton notes. The plastic note technology uses a polymer plastic substrate instead of paper. Compared to paper, plastic banknotes are stronger and non-porous.

However, plastic banknotes have the disadvantage that a number of safety features such as real multitone watermarks, windowed security threads which are successfully used in paper notes, can not be used or are less effective when used in plastic notes.

Therefore it is an object of the present invention to provide a new method for printing security items, in particular, a method for printing a security item on banknotes, with which the above mentioned drawbacks are overcome and which results in a security item with a much higher security level against counterfeiting than the known methods.

The above mentioned object is achieved by providing a new method for printing a security item on a substrate of which at least a part is made of a transparent material, in which a first part of an image is printed on one side of the transparent material, and a second complementary part of the image is printed on the opposite side of the transparent material such that, at least some angles of view, the image is visible or can be visualised as a whole in which the first and second complementary part of the image are not distinguishable.

In a preferred method according to the invention the first and second part of the image are not distinguishable at first angle of view which is essentially perpendicular to the surface of the substrate.

The expression “image” as used in this text refers to any representation, text, message, symbol, pattern and alike, which may be applied on a document in visible form or which may be visualised under specific light circumstances, for example use of an invisible fluo ink which becomes visible under black light, the use of Infra-Red (IR) absorbent ink, . . . . The image can according to the invention be printed in single colour or multi colour.

In a preferred method at least a part of the image comprises indicia, such as lines, solid areas, security backgrounds and/or dots, said first part and said second complementary part of the image being constituted by some of said indicia.

In another preferred method at least a part of the image comprises indicia, such as lines, solid areas, security backgrounds and/or dots in at least two different colours, said first part of the image being constituted by the indicia in at least one particular colour of said colours.

Documents according to the invention preferably comprise a transparent synthetic material such as polyethylene, polyester, polypropylene, polycarbonate, polyamide or combination thereof. However, plastic substrates made from one or more other materials may be used as well.

This invention enables the printer of security documents to improve the security level of security documents, through an optimal use of the technical possibilities of existing banknote presses. Preferably, the first part and the second complementary part of the image are printed in see-through register, preferably by means of a banknote press which puts the different parts of the image simultaneously on both sides of the substrate.

In a preferred method for printing a security item according to the invention, the first part of the image is at least one area of the whole image, said area being surrounded by the second complementary part. The first part is preferably shaped in such a way that it represents a message (e.g. the numeral 5).

In a further preferred method according to the invention, the first part of the image is distinguishable from the second part at a second angle of view. The message of the first part will not be visible in transmission at the first angle (P°) which is essentially perpendicular to the surface of the substrate. The fact that the message of the first part is not visible is due to the fact that both parts (images) are printed in perfect see-through register. As soon as a counterfeiter has a problem to print the parts on the front and the back in register on the substrate, the first part of the image will appear, as a kind of outline and the message will be visible at any angle of view.

According to a more preferred method for printing a security item according the invention, the first part of the image and/or the second complementary part of the image are printed using an ink which is less reflective than the transparent material. Preferably, the first part and the complementary second part of the image are printed in matt ink on a glossy transparent material.

According to another preferred method for printing security items, the first part of the image and/or the second complementary part of the image are printed using an ink which is more reflective than the transparent material. Preferably the first part and the complementary second part of the image are printed in glossy ink on a matt transparent material.

This patent application also relates to a printed security item on a substrate of which at least a part is made of a transparent material in which a first part of an image is printed on one side of the transparent material, and a second complementary part of the image is printed on the opposite side of the transparent material such that, at least at some angles of view the image is visible or can be visualised as a whole in which the first and second part of the image are not distinguishable.

The printed security item is preferably manufactured applying a method according to any of the claims 2 to 10.

In a more preferred embodiment of the invention said substrate is a security document. In particular, said security document is a banknote.

As this invention is meant to be printed on a transparent substrate it is clear that beyond the traditional printing techniques all possible techniques for transferring or generating an image on such a substrate can be used, such as inkjet, thermal transfer, sublimation, etc.

Additional features and advantages of the invention will be further explained on the basis of non-restricting exemplifying embodiments represented in the attached drawings and in the following detailed description. In this description reference is made to the following drawings in which:

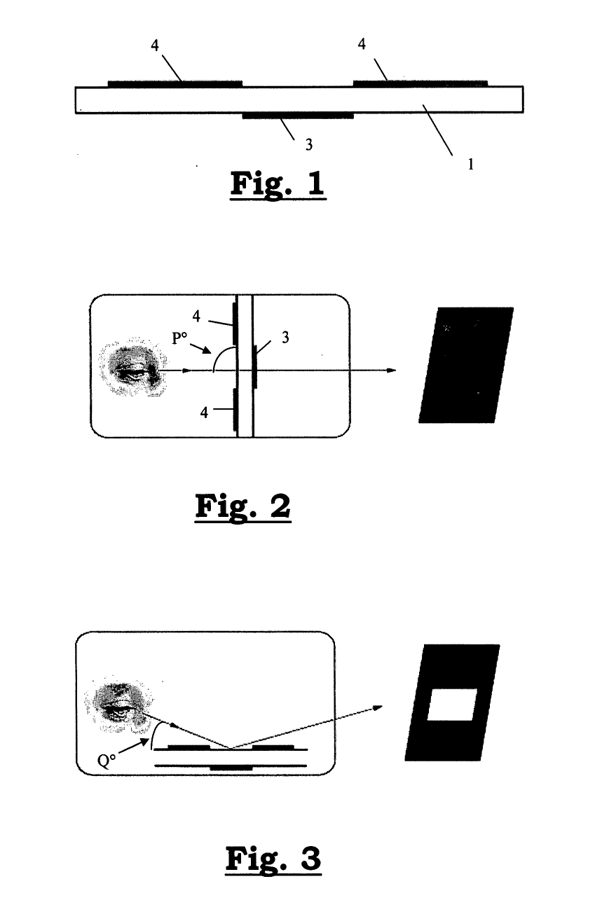

FIG. 1 is a representation of a printed security item on a substrate;

FIG. 2 shows that the angle of view is perpendicular to the image;

FIG. 3 shows that the angle of view is changing;

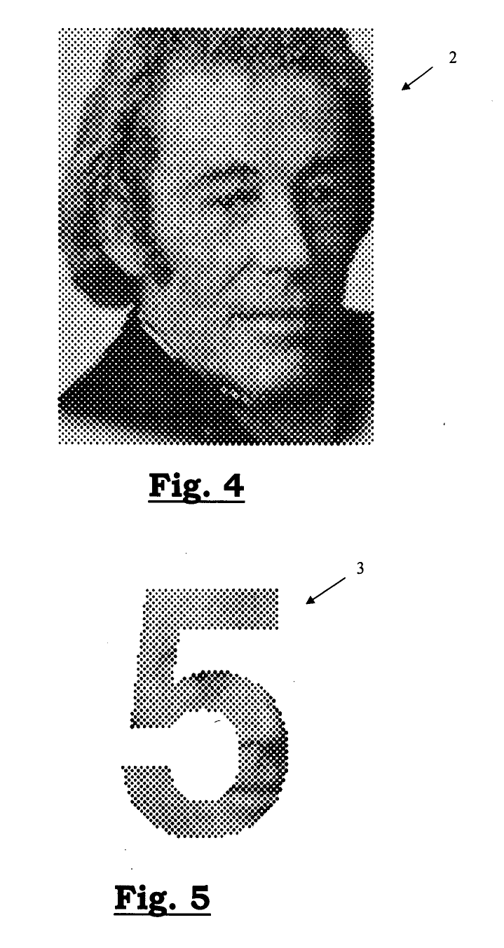

FIG. 4 is a representation of a screened monochrome image which can be printed on a security document;

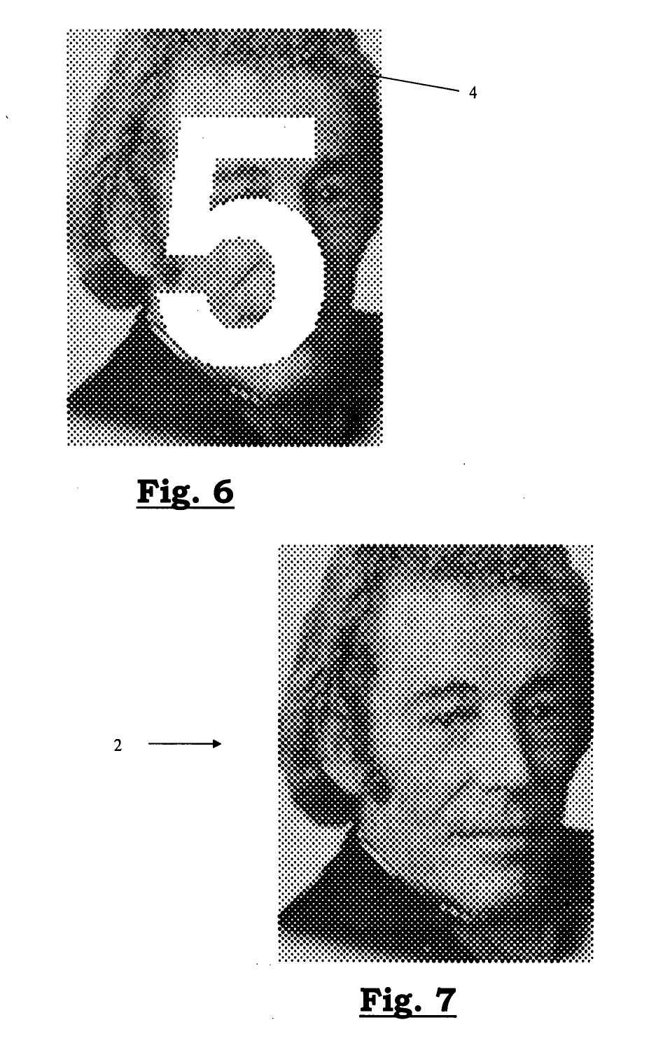

FIG. 5 is representation of the first part of the monochrome image of FIG. 4;

FIG. 6 shows the complementary second part of the monochrome image of FIG. 4;

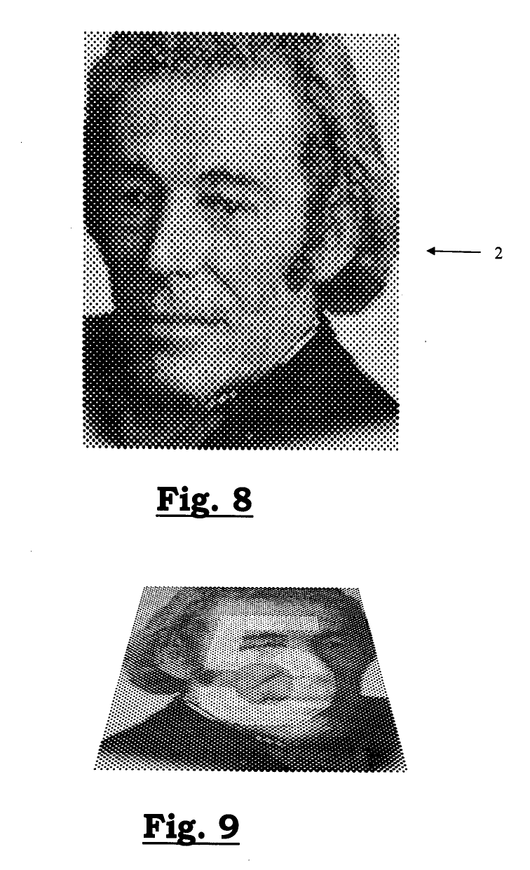

FIGS. 7 and 8 are a representation of the front and backside of the image when looking at it perpendicularly;

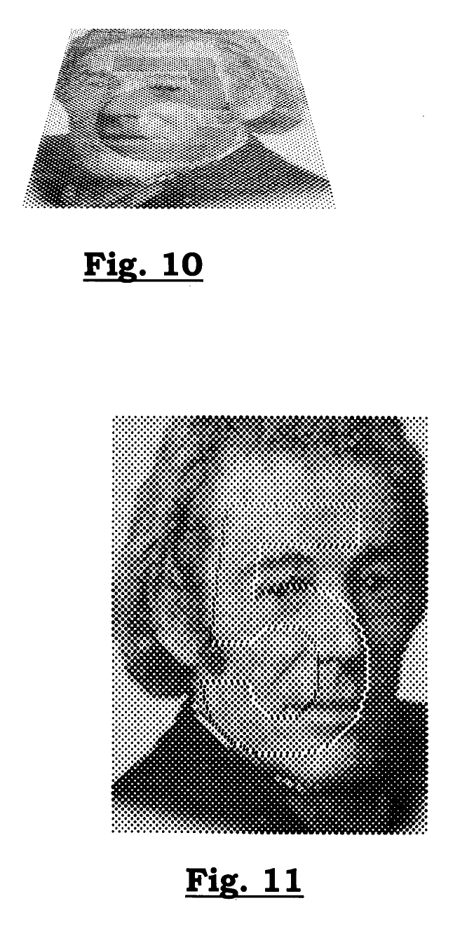

FIGS. 9 and 10 are a representation of the front and backside of the image when looking at it after changing the angle of view;

FIG. 11 is a representation of an image of which the first and second parts are not printed in perfect register.

According to the method of the invention, security documents, such as banknotes, printed on a substrate (1) of which at least a part is made of a transparent material, for example polypropylene or polyester, can be provided with a new security item via known banknote presses. Another possibility is transferring a transparent substrate, comprising a security item according to the invention, to a document.

Therefore an image (2), for example the picture of a person (see FIG. 4), will be provided on a glossy transparent substrate. This image (2) will be separated in two parts (3 and 4). A first part (3) of the image will be printed with mat ink on the glossy transparent (part of) the substrate (1). The complementary second part (4) will be printed in perfect register on the other side of the transparent substrate (1), with mat ink as well.

The first part (3) is a well defined area of the image (2) and is preferably surrounded by the complementary second part (4). In this example, the selected area has the form of the numeral 5. The first part (3) constitutes a message (in this example the denomination 5) and will be printed in a specific colour and density on one side of the substrate (1), now considered as the back side of the transparent substrate (1) (see FIG. 5). At the same time, the complementary second part (4) of the image (2) will be printed in perfect register on the opposite side of the transparent substrate (1) with the same colour and density as the first part (see FIG. 6). When one looks at the document in transmission in such a way that the angle of view (P°) is about 90°, which is essentially perpendicular to the substrate (1) (as shown in FIG. 2), the complete image (2) is visible (see FIGS. 7 and 8). The first part (3) and the second part (4) of the image can not be distinguished, and the message (e.g. numeral 5) is not visible. The fact that the message is not distinguishable from the rest of the image (2) is also due to the fact that both parts (3 and 4) are printed in perfect see-through register.

The message will be visible only when changing the angle of view (Q°) in reflection, for example when one looks at the document at the front side at an angle of view (Q°) such that the light reflects on the front side of the glossy substrate, then the first part (3) of the image (on the back side) is invisible or less visible because of the light reflection on the front side of the glossy substrate (see FIG. 9). The complementary second part (4) printed on the front side remains clearly visible because the light does not reflect, or reflects to a lesser degree on the matt ink surface (see also FIG. 9). As a result thereof, the first part (3) of the image (2) will be distinguishable from the second part, and the message will appear. When one looks at the document at the back side at an angle of view (Q°) such that the light reflects on the back side of the glossy substrate, then the second part (4) of the image (on the front side) is invisible or less visible because of the light reflection on the back side of the glossy substrate (see FIG. 10). The first part (3) printed on the back side remains clearly visible because the light does not reflect or reflects to a lesser degree on the matt ink surface (see also FIG. 10)

When a counterfeiter has a problem with printing in perfect register on the back and the front side of a substrate, the message will appear as a kind of outline, as shown in FIG. 11.

In the method according to this invention, it is also possible to include at least one multicolour image. Such an image may, for example, be constituted of a first and a second complementary part comprising printed indicia in three different colours.

In applying this method, one can choose to print all the indicia of the first part of this multicolour image on one side of the substrate and to print only the indicia in one or two colours of the second complementary part on the other side of the substrate or vice versa.

In the example described above, the numeral “5” can be composed of indicia in three different colours, and the indicia in one, two or three of these colours can be printed on the backside of the substrate.

It is also possible to print the first part of the image in a single colour, whereas the second complementary part is printed in multicolour, and vice versa. In this case, the first part of the image can be printed in a Pantone colour and the second part of the image can be printed in a multicolour simulation of said Pantone colour, and vice versa.

Applying this method results in banknotes and other security documents being provided with a security item, which is extremely difficult to counterfeit and which is easily verifiable. Further important advantages are that this method is not complex and that it can be applied on existing printing presses.

It is also possible to transfer or place a transparent substrate, which comprises a security item according the invention, using known technologies or techniques to a document, . . . . This method can be combined with other known security features for security documents, such as banknotes.

1. Method for printing a security item on a substrate (1) of which at least a part is made of a transparent material characterised in that a first part (3) of an image (2) is printed on one side of the transparent material, and that a second complementary part (4) of the image (2) is printed on the opposite side of the transparent material such that, at least some angles (P°) of view, the image (2) is visible or can be visualised as a whole in which the first (3) and second (4) part of the image (2) are not distinguishable.

2. Method for printing a security item according to claim 1, characterised in that the first (3) and second (4) part of the image are not distinguishable at a first angle (P°) of view which is essentially perpendicular to the surface of the substrate (1).

3. Method for printing a security item according to claim 1, characterised in that the first part (3) of the image (2) is at least one area of the whole image (2), said area being surrounded by the second complementary part (4).

4. Method for printing a security item according to claim 1, characterised in that at least a part of the image (2) comprises indicia, such as lines, solid areas, security backgrounds and/or dots, said first part (3) and said second complementary part (4) of the image (2) being constituted by some of said indicia.

5. Method for printing a security item according to claim 4, characterised in that at least a part of the image (2) comprises indicia, such as lines, solid areas, security backgrounds and/or dots in at least two different colours, said first part (3) of the image (2) being constituted by the indicia in at least one particular colour of said colours.

6. Method for printing a security item according to claim 1, characterised in that the first part (3) of the image (2) and the second complementary part (4) of the image (2) are printed in see-through register.

7. Method for printing a security item according to claim 1, characterised in that the first part (3) of the image (2) is distinguishable from the second part (4) at a second angle (Q°) of view.

8. Method for printing a security item according to claim 1, characterised in that the first part (3) of the image and/or the second complementary part (4) of the image (2) are printed using an ink which is less reflective than the transparent material.

9. Method for printing a security item according to claim 1, characterised in that the first part (3) of the image (2) and/or the second complementary part (4) of the image (2) are printed using an ink which is more reflective than the transparent material.

10. Method for printing a security item according to claim 1, characterised in that the transparent material is a synthetic material.

11. Printed security item on a substrate (1) of which at least a part is made of a transparent material characterised in that a first part (3) of an image (2) is printed on one side of the transparent material, and that a second complementary part (4) of the image (2) is printed on the opposite side of the transparent material such that, at least at some angles (P°) of view the image (2) is visible or can be visualised as a whole in which the first (3) and second (4) part of the image (2) are not distinguishable.

12. Printed security item according to claim 11, characterised in that the security item is manufactured by a method, wherein the method comprises printing a security item on a substrate (1) of which at least a part is made of a transparent material characterised in that a first part (3) of an image (2) is printed on one side of the transparent material, and that a second complementary part (4) of the image (2) is printed on the opposite side of the transparent material such that, at least some angles (P°) of view, the image (2) is visible or can be visualised as a whole in which the first (3) and second (4) part of the image (2) are not distinguishable, and wherein the first (3) and second (4) part of the image are not distinguishable at a first angle (P°) of view which is essentially perpendicular to the surface of the substrate (1).

13. Printed security item on a substrate according to claim 12, characterised in that said substrate is a security document.
